(19) United States
(12) Patent Application Publication
(10) Pub. No.: US 2019/0227634 A1
(43) Pub. Date: Jul. 25, 2019

(54) CONTEXTUAL GESTURE-BASED IMAGE SEARCHING

(71) Applicant: International Business Machines Corporation, Armonk, NY (US)

(72) Inventors: James E. Bostick, Cedar Park, TX (US); John M. Ganci, Jr., Cary, NC (US); Martin G. Keen, Cary, NC (US); Sarbajit K. Rakshit, Kolkata (IN)

(21) Appl. No.: 15/875,392

(22) Filed: Jan. 19, 2018

(51) Int. Cl. G06F 3/01; G06F 17/30; G06F 3/041; G06F 3/0488

(52) U.S. Cl. CPC G06F 3/017; G06F 3/0488; G06F 3/041; G06F 17/30265

(57) ABSTRACT

Performing an image search on a mobile device, initiated through an issuance of contextual gestures on a touch screen by the user. A user opens a photograph, issues a gesture on that photograph via the touch screen. The gesture generates a search query looking for photographs that match the criteria of that search query indicated by the gesture. For example by issuing a pinching gesture on a photograph of a person's mouth the user can search for photographs of that person where they are smiling. The gestures may be emotion-based, time-based, or size-based contextual gestures, and utilizes cognitive image analysis for locating appropriate photographs.

### BACKGROUND

The present invention relates to contextual gesture-based image searching, and more specifically to contextual gesture-based image searching on devices with a touch interface.

Photography on mobile devices continues to gain popularity. Mobile device users are building up large repositories of photographs taken on these devices. In addition, the popularity of photo sharing social networks are increasing the number of photographs stored online. Providing intuitive methods to search these large repositories is becoming ever more important.

Advancements in cognitive techniques and object recognition enable deep analysis into what a photograph is showing. Additionally social networks add tags to photographs. Therefore, for a given photograph it is possible to tell who is in a photograph, what emotion is portrayed on their face, when and where the photograph was captured, and many other factors.

Existing solutions for image searching can use gestures. While each has slight differences, the main theme is for a user to select an object in a photograph by either tapping the photo or circling a portion of the photo with a gesture, then identifying other instances of photographs where that object also appears.

### SUMMARY

According to one embodiment of the present invention, a method of contextual gesture based image searching in at least one repository is disclosed. The method comprising the steps of: a computer displaying an image selected by the user on a touchscreen of the device to the user; the computer receiving gestures on the image via the touchscreen from the user; the computer identifying the gesture issued through analyzation of the gesture and the location of the gesture on the image; and the computer performing an image search within the least one repository for at least one image based on the identified gesture.

According to another embodiment of the present invention, a computer program product for contextual gesture based image searching in at least one repository is disclosed. The computer program product using a computer comprising at least one processor, one or more memories, one or more computer readable storage media, the computer program product comprising a computer readable storage medium having program instructions embodied therewith. The program instructions executable by the computer to perform a method comprising: displaying, by the computer, an image selected by the user on a touchscreen of the device to the user; receiving, by the computer, gestures on the image via the touchscreen from the user; identifying, by the computer, the gesture issued through analyzation of the gesture and the location of the gesture on the image; and performing, by the computer, an image search within the least one repository for at least one image based on the identified gesture.

According to another embodiment of the present invention, a computer system for contextual gesture based image searching in at least one repository is disclosed. The computer system comprising a computer comprising at least one processor, one or more memories, one or more computer readable storage media having program instructions executable by the computer to perform the program instructions comprising: displaying, by the computer, an image selected by the user on a touchscreen of the device to the user; receiving, by the computer, gestures on the image via the touchscreen from the user; identifying, by the computer, the gesture issued through analyzation of the gesture and the location of the gesture on the image; and performing, by the computer, an image search within the least one repository for at least one image based on the identified gesture.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3a shows an example of a user issuing a contextual gesture to search images for a subject smiling.

FIG. 3b shows an example of a search result of the search initiated by the user in FIG. 3a.

FIG. 4a shows an example of an emotion search gesture for the emotion of happy.

FIG. 4b shows an example of an emotion search gesture for the emotion of sad.

FIG. 4c shows an example of an emotion search gesture for the emotion of surprised.

FIG. 4d shows an example of an emotion search gesture for the emotion of upset.

FIG. 5a shows an example of a time based search gesture for older images.

FIG. 5b shows an example of a time based search gesture for younger images.

FIG. 5c shows an example of a time based search gesture for an earlier image.

FIG. 5d shows an example of a time based search gesture for a later image.

FIG. 6a shows an example of a size based search gesture for a larger image.

FIG. 6b shows an example of a size based search gesture for a smaller image.

FIG. 7 shows a flowchart of a method of cognitive analysis of images.

FIG. 8 shows a flowchart of a method of contextual gesture based image searching.

### DETAILED DESCRIPTION

It should be noted that for the purposes of this application, the term “photograph” or “image” or “picture” refers to an electronic image, which can be stored in a repository or memory.

It will be recognized in an embodiment of the present invention, that the system provides a dynamic image search with the capability to issue a contextually sensitive gesture and find pictures of the same person expressing a particular emotion, or to find pictures where a given person is younger or older than in the currently displayed picture.

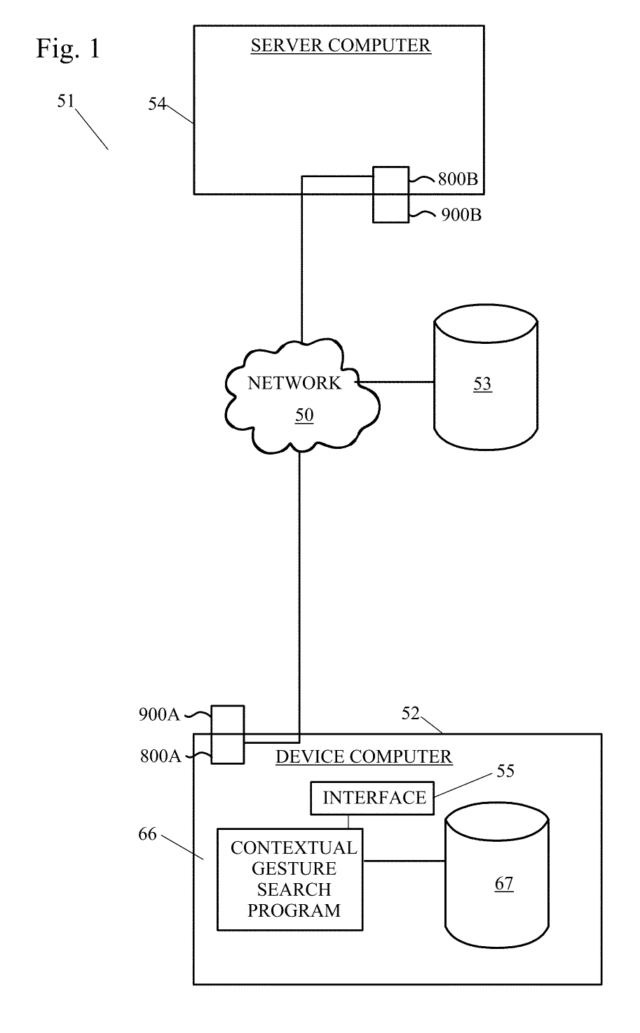

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, and a server computer 54 connect to network 50. In other exemplary embodiments, network data processing system 51 may include additional client or device computers, storage devices or repositories, server computers, and other devices not shown.

The repository 53 may contain electronic photographs with tagging and associated metadata. The electronic photographs may have been stored in the repository by a device computer 52 and may be associated with a social network user profile. The repository may be analyzed by a cognitive system to determine content of pictures, and is combined with existing metadata and tagging to create a metadata repository.

The device computer 52 may contain an interface 55, which may accept commands and data entry from a user. The commands may be regarding gestures indicating search terms. The interface can be, for example, a command line interface, a graphical user interface (GUI), a natural user interface (NUI) or a touch user interface (TUI), but is preferably a touch user interface. The device computer 52 may contain a repository. The device computer 52 may be a personal device, mobile device, or any device with a touchscreen for receiving input.

The repository 67 may contain electronic photographs with tagging and associated metadata. The electronic photographs may have been stored in the repository by a device computer 52 and may be associated with a social network user profile. The repository may be analyzed by a cognitive system to determine content of pictures, and is combined with existing metadata and tagging to create a metadata repository 53.

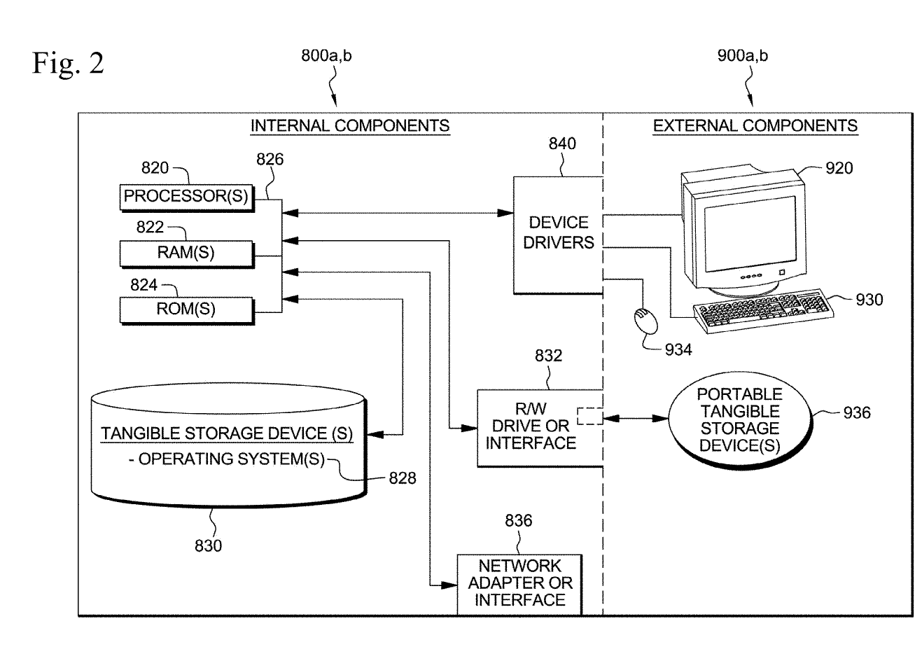

The device computer 52 preferably includes contextual gesture search program 66. While not shown, it may be desirable to have the contextual gesture search program 66 be present on the server computer 54. The device computer 52 includes a set of internal components 800a and a set of external components 900a, further illustrated in FIG. 2.

Server computer 54 includes a set of internal components 800b and a set of external components 900b illustrated in FIG. 2. In the depicted example, server computer 54 provides information, such as boot files, operating system images, and applications to the device computer 52. Server computer 54 can compute the information locally or extract the information from other computers on network 50. The server computer 54 may contain the contextual gesture search program 66.

Program code and programs such as contextual gesture search program 66 may be stored on at least one of one or more computer-readable tangible storage devices 830 shown in FIG. 2, on at least one of one or more portable computer-readable tangible storage devices 936 as shown in FIG. 2, or on repository 53 connected to network 50, or may be downloaded to a device computer 52 or server computer 54, for use. For example, program code and programs such as contextual gesture search program 66 may be stored on at least one of one or more storage devices 830 on server computer 54 and downloaded to device computer 52 over network 50 for use. Alternatively, server computer 54 can be a web server, and the program code, and programs such as contextual gesture search program 66 may be stored on at least one of the one or more storage devices 830 on server computer 54 and accessed device computer 52. In other exemplary embodiments, the program code, and programs such as contextual gesture search program 66 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 1, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and contextual gesture search program 66 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Contextual gesture search program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Contextual gesture search program 66 can be downloaded to the device computer 52 and server computer 54 from an external computer via a network (for example, the Internet, a local area network or other, wide area network) and network adapter or interface 836. From the network adapter or interface 836, contextual gesture search program 66 is loaded into hard drive 830. Contextual gesture search program 66 can be downloaded to the server computer 54 from an external computer via a network (for example, the Internet, a local area network or other, wide area network) and network adapter or interface 836. From the network adapter or interface 836, contextual gesture search program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Contextual gesture search program 66 can be written in various programming languages including low-level, high-level, object-oriented or non object-oriented languages. Alternatively, the functions of a contextual gesture search program 66 can be implemented in whole or in part by computer circuits and other hardware (not shown).

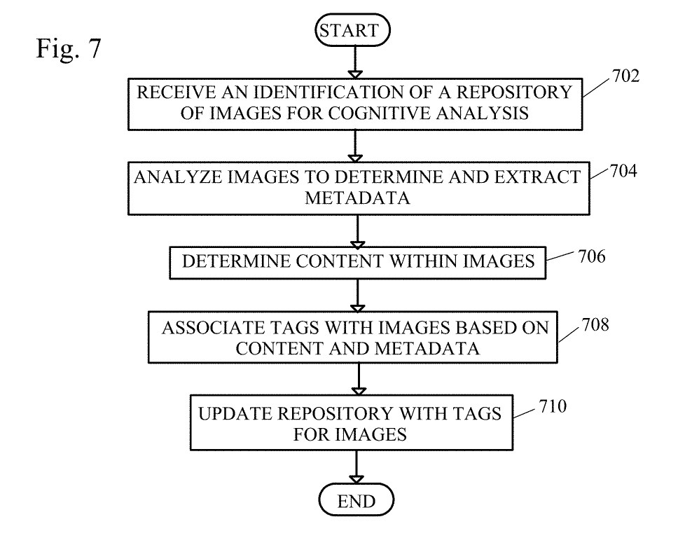

FIG. 7 shows a flowchart of a method of cognitive analysis of images for creation of a content aware image repository.

In a first step, an identification of a repository of electronic images for cognitive analysis is received (step 702), for example by the contextual gesture search program 66. The repository 67, 53 may consist of photographs stored: locally on a mobile device 52; cloud-based such as a social network account, or other repositories.

The images within the identified repository are analyzed to determine and extract any metadata of the images (step 704) and to determine the content within the images (step 706), by the contextual gesture search program 66.

Tags are associated with the images based on the identified content and metadata (step 708), for example by the contextual gesture search program 66. The repository is updated (step 710) and the method ends.

Cognitive techniques can be used to build up metadata and tags describing the content of the images in the identified repository. AlchemyVision® employs deep learning to understand a picture's content and context. This can determine factors such as who is in frame, their gender and age, and high level tags about their surroundings. Visual Recognition determines and understands the contents of image to create classifiers which identify objects, events, and settings. The cognitive techniques may be combines with existing metadata associated with a photograph (such as information stored in an exchangeable image file format (EXIF) metadata as social tagging) and stored in a repository. This metadata includes fields such as: date of capture; location of capture; identified people; identified facial expressions; and identified objects.

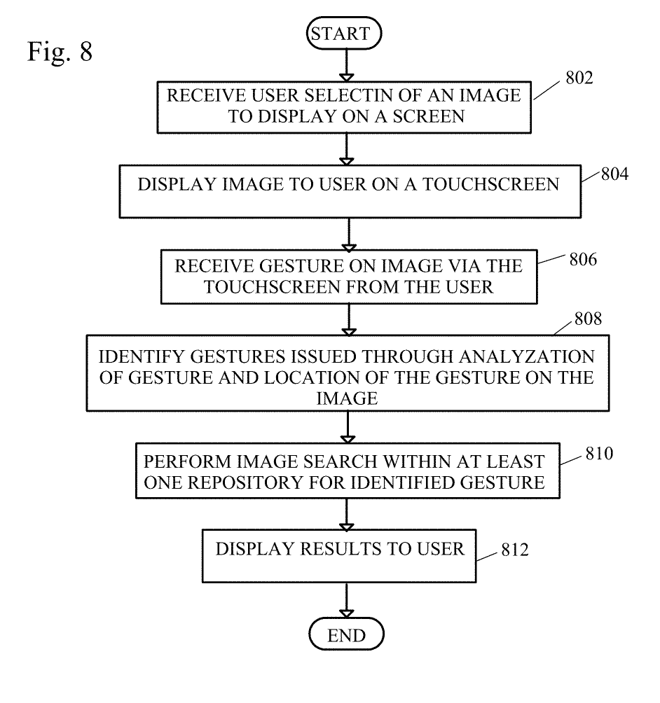

FIG. 8 shows a flowchart of a method of contextual gesture based image searching.

In a first step, the contextual gesture search program 66 receives a user selection of an image to display on a touchscreen of a device, to the user (step 802).

The image is displayed to the user on the touchscreen of the device (step 804).

The contextual gesture search program 66 receives gestures on an image via the touchscreen from the user (step 806). This gesture indicates the type of image search to be performed.

Gestures can be pre-defined by the system, and can be customized by the user so that a specific gesture performs a specific search. When the user issues a gesture the system records the following information: the gesture issued (for example: pinching gesture) and the location of the gesture (for example: XY coordinates).

The gesture issued is identified through analyzation of the gesture and the location of the gesture on the image (step 808). The system calculates the gesture issued by determining what is located in the image at the location of the issued gesture.

There are different types of image based searching that occurs relative to the gesture issued and the associated context of the image.

An emotion based search gesture is a gesture which is received by the system over the face of a person within the image. For example a pinching motion over the mouth of a person indicates a command to perform a search for other images, where this person is expressing an emotion of sadness. An upward motion gesture over an eye indicates to search for photographs of this person looking surprised.

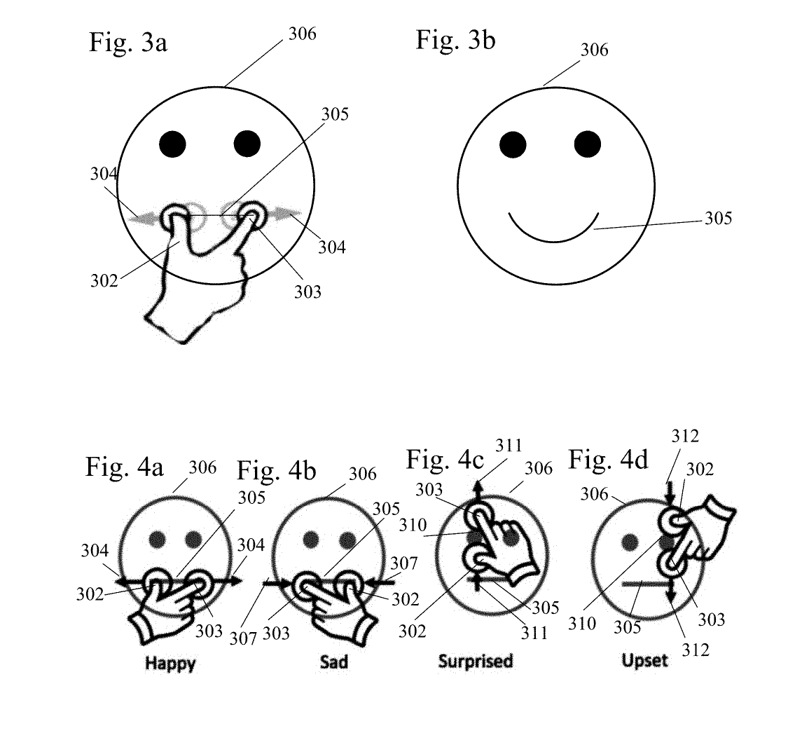

FIG. 3a shows an example of a user issuing a contextual gesture to search for images for a subject smiling The issued gesture is an expanding gesture (indicated by outward arrows 304) between two fingers 302, 303 of the user, with the user moving their fingers 302, 303 away from each other over the mouth 305 of a person 306 (shown as cartoon) within the image. Based on the contextual gesture received, the contextual gesture search program 66 searches for other images of the same person smiling. It should be noted that these searches can be used with photographs of people. FIG. 3b shows an example of a search result of the search initiated by the user in FIG. 3a. This gesture can also be associated with a search for the emotion of happy as shown in FIG. 4a.

FIG. 4b shows an example of an emotion search gesture for the emotion of sad. The issued search gesture is pinching (indicated by inwards arrows 307) between two fingers 302, 303 of the user on a mouth 305 of a person 306 within the image. Based on the contextual gesture received, the contextual gesture search program 66 searches for other images of the same person who is sad.

FIG. 4c shows an example of an emotion search gesture for the emotion of surprised. The issued search gesture is an expanding gesture (indicated by outward arrows 311) between two fingers 302, 303 of the user, with the user moving their fingers away from each other over at least one eye 310 of a person 306 within the image. Based on the contextual gesture received, the contextual gesture search program 66 searches for other images of the same person who is surprised.

FIG. 4d shows an example of an emotion search gesture for the emotion of upset. The issued search gesture is a pinching gesture (indicated by inwards arrows 312) between two fingers 302, 303 of the user, with the user moving their fingers 302, 303 towards each other over at least one eye 310 of a person 306 within the image. Based on the contextual gesture received, the contextual gesture search program 66 searches for other images of the same person who is upset.

The contextual search of emotions is not limited to the examples given above. Additional emotions may be searched for and defined by the user or predefined by the system. Furthermore, while the examples referenced searching for people displaying emotions, the search may apply to animals or other objects displaying emotions, such as inanimate objects or computer-generated people.

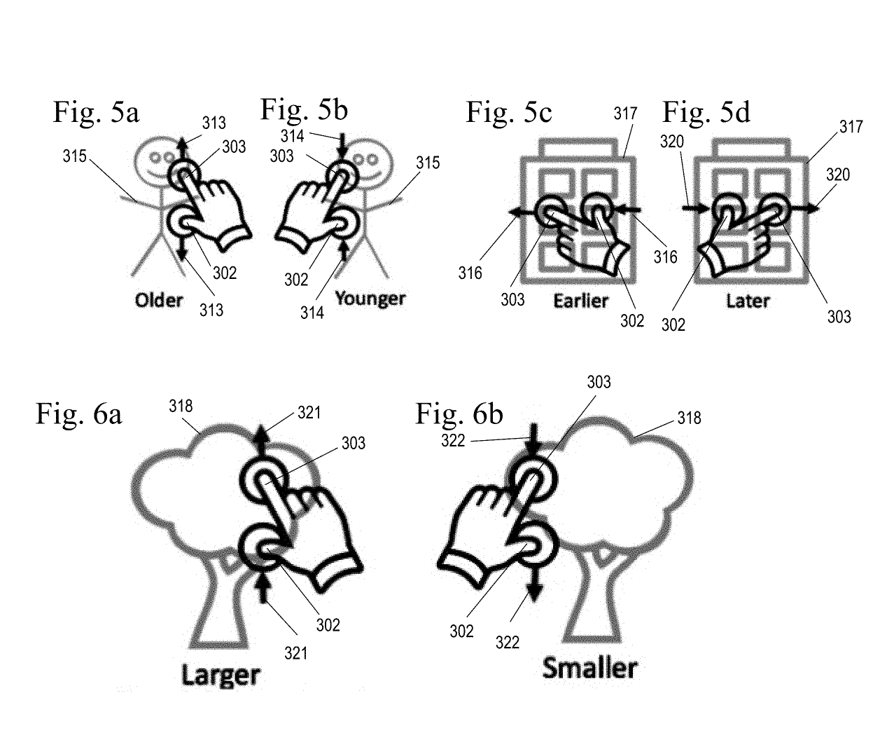

A time-based search gesture is gesture performed over a person or an object within an electronic image. The time-based search gesture allows a user to search for images of a person which are older or younger (see FIGS. 5a and 5b) or an earlier or later version of an object (see FIGS. 5c and 5d).

FIG. 5a shows an example of a time-based search gesture for older images. The issued search gesture is an expanding gesture (indicated by outward arrows 313) between two fingers 302, 303 of the user, with the user moving their fingers 302, 303 away from each other over the person 315 within the image. Based on the contextual gesture received, the contextual gesture search program 66 searches for other images of the same person 315 which are older than the current image of the person.

FIG. 5b shows an example of a time-based search gesture for younger images. The issued search gesture is pinching (indicated by inward arrows 314) between two fingers 302, 303 of the user on the person 315 within the image, with the user bringing their fingers 302, 303 together. Based on the contextual gesture received, the contextual gesture search program 66 searches for other images of the same person 315 which are younger than the current image of the person.

FIG. 5c shows an example of a time-based search gesture for an earlier image. The issued search gesture is a leftward gesture (indicated by arrows 316) by the user's fingers 302, 303 over the object 317 in the image, which in this case is building. Based on the contextual gesture received, the contextual gesture program 66 searches for other images of the object 317 which are earlier than the object in the image. In the example of object in the image being a building, an earlier picture of the building may be during construction versus the finished building.

Similarly, FIG. 5d shows an example if a time-based search gesture for a later image. The issued search gesture is a rightward gesture (indicated by arrows 320) over the object 317 in the image, which in this case is building. Based on the contextual gesture received, the contextual gesture program 66 searches for other images of the object 317 which are earlier than the object currently displayed in the image. In the example of object in the image being a building, a later picture of the building may be the finished building versus a picture of the building under construction, in which the issued gesture was received on.

A size-based search gesture is a gesture performed over an object for different sizes of the object.

For example, FIG. 6a shows an example of a size based search gesture for a larger image. The issued search gesture is an expanding gesture (indicated by outward arrows 321) between two fingers 302, 303 of the user, with the user moving their fingers 302, 303 away from each other over the object 318 within the image. Based on the contextual gesture received, the contextual gesture search program 66 searches for other images of the object 318 which are larger than the object in the current image.

FIG. 6b shows an example of a size based search gesture for a smaller image. The issued search gesture is pinching (indicated by inward arrows 322) between two fingers 302, 303 of the user on the object 318 within the image, with the user bringing their fingers together. Based on the contextual gesture received, the contextual gesture search program 66 searches for other images of the object 318 which are smaller than the object in the current image.

The contextual gesture search program 66 performs an image search within at least one repository for the identified gesture (step 810) and the results are displayed to the user (step 812) and the method ends.

The repository which is searched may be a content aware image repository in which the images were pre-analyzed for content. The repository is preferably created using the method of FIG. 7. The content aware image repository 67 contains metadata and tags for each photograph within that repository. In this instance the system performs a simple search, using the criteria indicated by the user with their gesture to search the metadata and associated tags. For example, the contextual search program 66 may search for images of the Empire State Building within a user's personal device or social network user profile which are older than the current image being displayed on the user's device.

Alternatively or in addition to the content aware image repository 53, other image repositories may also be searched. For example, the contextual search program 66 in addition to or alternatively may search for pictures of the Empire State Building taken before 2016 in a public image repository.

The results of the search may be presented to the user through a touchscreen display of the user's device 52. The images corresponding to the results of the search may be presented as image thumbnails which the user can select to view full size. The user can indicate which images from the search they prefer or most match their criteria, and this preference can be taken into account when the user issues future image searches.

The creation of the content aware image repository 67 decreases the resources required for the processor to conduct an image search and thus increases the speed in which a processor of the user's device can conduct such a search.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of contextual gesture based image searching in at least one repository comprising the steps of:
a computer displaying an image selected by the user on a touchscreen of the device to the user;
the computer receiving gestures on the image via the touchscreen from the user;
the computer identifying the gesture issued through analyzation of the gesture and the location of the gesture on the image; and
the computer performing an image search within the least one repository for at least one image based on the identified gesture.

2. The method of claim 1, wherein the repository is a content aware image repository created by:
the computer analyzing images within a repository to determine and extract metadata of the images;
the computer determining content within the images; and
the computer associating tags with the images based on the identified content and metadata.

3. The method of claim 2, wherein the metadata is data stored in an exchangeable image file format associated with the image.

4. The method of claim 1, wherein the gesture is further identified based on determining the content of what is located in the image at the location of the gesture issued.

5. The method of claim 1, further comprising displaying results of the image search to the user.

6. The method of claim 1, wherein the gesture issued is a pinching motion or expanding motion between two fingers of the user.

7. The method of claim 6, wherein the pinching motion or expanding motion is located on a face of person or animal, such that the image search is for an emotion being displayed by the person or animal.

8. The method of claim 6, wherein the pinching motion or expanding motion is located on an object, such that the image search is for a smaller or larger size of the object being displayed in the image.

9. The method of claim 6, wherein the pinching motion or expanding motion is located on a person or animal, such that the image search is for an older or younger image of the person or animal being displayed in the image.

10. The method of claim 7, wherein the pinching motion is on a mouth of the person or animal, such that the image search is for other images of the person or animal which are sad.

11. The method of claim 7, wherein the expanding motion is on a mouth of the person or animal, such that the image search is for other images of the person or animal which are happy.

12. The method of claim 7, wherein the pinching motion is on an eye of the person or animal, such that the image search is for other images of the person or animal which are upset.

13. The method of claim 7, wherein the expanding motion is on an eye of the person or animal, such that the image search is for other images of the person or animal which are surprised.

14. The method of claim 1, wherein the gesture issued is leftward or rightward swipe between two fingers of the user.

15. The method of claim 14, wherein the leftward swipe is located on an object, such that the image search is for an object earlier than the object being displayed in the image.

16. The method of claim 14, wherein the rightward swipe is located on an object, such that the image search is for an object later than the object being displayed in the image.
